(19) United States
(12) Patent Application Publication
(10) Pub. No.: US 2004/0051757 A1
(43) Pub. Date: Mar. 18, 2004

(54) Method of making holes and structures comprising such holes

(76) Inventor: Patrik Holland, Uppsala (SE)

Correspondence Address: YOUNG & THOMPSON, 745 SOUTH 23RD STREET 2ND FLOOR, ARLINGTON, VA, 22202

(21) Appl. No.: 10/399,665

(22) PCT Filed: Oct. 17, 2001
(86) PCT No.: PCT/SE01/02250

(30) Foreign Application Priority Data
Oct. 20, 2000 (SE) 0003799-4

(51) Int. Cl. G11B 5/127

(52) U.S. Cl. 347/47; 216/27

(57) ABSTRACT

A miniature nozzle structure, comprising an essentially flat member having a top and a bottom surface, and having a first opening provided on the bottom surface, and a second opening provided on the top surface, thereby forming a channel between the openings, and a transition region between the openings. The diameter of the first opening is larger than the diameter of the second opening. The geometrical shapes of the first and second openings, respectively, are different. The diameter of the channel is reduced in the direction from the first opening towards the second opening and up to the transition region, the diameter of the channel being constant from the transition region and to the second opening. The intersection between the different geometrical shapes in the transition region corresponds to a true geometrical intersection. A method for making holes is also disclosed, the method comprising lithographic techniques.

The present invention relates to methods of making holes in substrates, said holes having advanced geometries, and to structures comprising such holes, e.g. nozzles for various types of application. In particular the invention relates to such holes where the opposite openings have different cross sectional shape, and the intersection between the two geometries is a true geometrical intersection.

### BACKGROUND OF THE INVENTION

In many technological fields it is essential to make small holes having accurately controlled shape and size. Examples can be found in the ink jet printer technology, dispensing devices for various kinds of reagents, aerosol sprays for drugs etc. In addition to the geometry and size, the surface properties can be chemically modified to meet specific requirements for the application in question, e.g. the wettability can be controlled.

Among currently employed methods laser ablation and electroplating techniques can be mentioned. The former entails sublimation and is a complicated and costly process, utilizing a mask that defines shape and size of the holes. Another method is to use molding techniques wherein a positive mold half defining the holes by protruding “pins” must be closely fitted with a second mold half defining a lid or cover. If the fitting between molds is not perfect, a thin molding “skin” covering the hole will be left after the molding is finished. This skin must be removed by some physical intervention, and will most likely leave behind an imperfect edge which will have a detrimental effect on the function of hole in its application as e.g. a nozzle.

An example of a prior art technique for making holes is disclosed in applicants own Swedish patent application SE-0003293-8.

However, with the method disclosed therein it is not possible to make holes having different cross section at opposite ends and having a true intersection between the different cross sectional shapes.

There is a demand for holes and methods of making them, that enables an inlet opening to have one geometry and the outlet to have another geometry, different from that of the inlet.

The transition region inside a channel formed between two holes having two different geometries, i.e. the intersection between the different cross sectional geometries must not disturb the passage of material in the channel such that the expelled material behaves in an uncontrolled manner.

None of the prior art methods and holes made according to the teachings of the prior art meets this requirement to a satisfactory degree.

### SUMMARY OF THE INVENTION

Thus, there is a need in the art of making small holes for a method that enables the production of holes in which the cross section changes from the geometry of an inlet to the geometry of an outlet without any transitional obstacles caused by the manufacturing process, such as burrs caused by the molds.

The object of the present invention is therefore to provide such a method. The inventive method is defined in claim 1.

In another aspect of the invention there is also provided a nozzle structure comprising a hole having the above mentioned properties. Such a structure is defined in claim 10.

Advantages of the Present Invention are i.a. the Following:

it allows advanced hole geometries to be made;

it results in “true intersections” between complicated cross sections to be achieved, which are other wise impossible to create;

a molding “skin” that covers the holes as a result of conventional molding is eliminated;

the holes according to the invention provides a controlled direction of drops when dispensing material through the holes, when they are operated as nozzles.

### BRIEF DESCRIPTION OF THE DRAWINGS

The invention will now be described in detail with reference to the drawing figures, in which

FIG. 1 illustrates the true intersection between two geometrical shapes in a hole made in accordance with the present invention;

FIG. 2 shows a variety of possible opening geometries usable with the invention;

FIGS. 3-10 illustrate the manufacturing process according to the invention; and

FIG. 11 shows an embodiment of a miniature nozzle structure according to the invention.

### DETAILED DESCRIPTION OF PREFERRED EMBODIMENTS

For the purpose of the present invention the term “true intersection” shall be taken to mean an intersection between two three-dimensional shapes that corresponds to a mathematically constructed intersection.

A “hole” is to be understood as a channel like structure through an essentially flat member. The “hole” has a first opening and a second opening on opposite sides of said member. The geometries of said openings can be of optional shapes, and may be mutually different. In preferred embodiments of the invention the geometries are different.

The term “diameter” of a geometric shape is to be interpreted more broadly than the mathematical meaning of the term. Thus, for the purpose of the present invention, it shall mean the diameter of the smallest circle that totally circumscribes the shape in question.

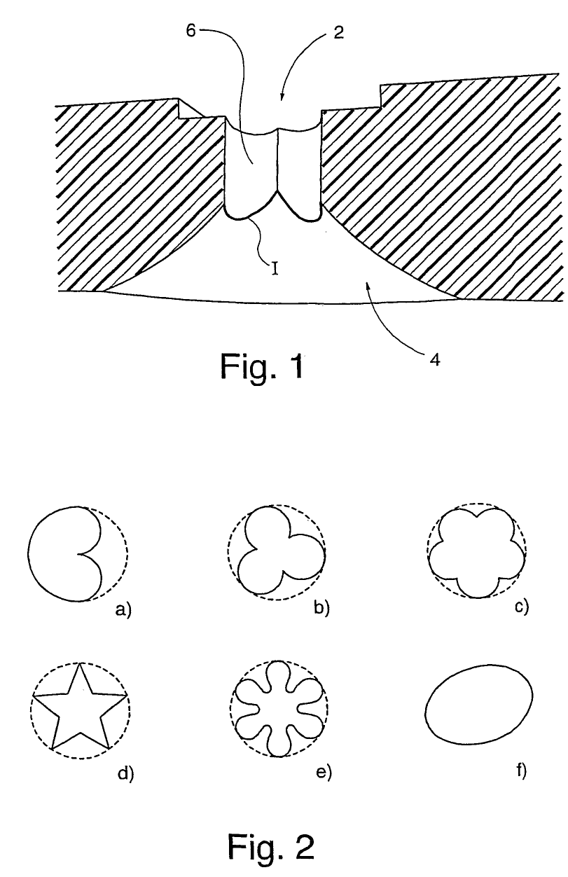

In order to illustrate the notion of a “true intersection” as defined above, let us consider FIG. 1.

This figure shows a cross-section of a hole 2 made according to the present invention, and comprising a trumpet bell shaped cone 4 having a circular base that is merged with a rectilinear tube 6 having a cross section of a “clover leaf”. The line of intersection between the two geometries is shown with a thick line I. It would be impossible to obtain a structure of the shown geometry with any of the prior art methods known to the inventors. If for example one tries to make this type of structure by joining two substrates, a first substrate having a conical hole, and the other having the clover leaf hole, inevitably edges would be obtained in the joint region. Such edges would cause the above mentioned transitional obstacles to matter flowing through the channel.

The structure shown in FIG. 1, although being given for illustration purposes only, may very well be usable also for practical applications, e.g. as a nozzle for dispensing various liquid materials (illustrative examples for applications will be given below). For reasons of controlling flow through the channel by reducing the turbulence and direct the pressure pulse in the liquid against the outlet hole it is desirable that the conical part will be of a trumpet like configuration, i.e. that the surface defining this three-dimensional geometrical shape is defined by a curved generator. This curve can follow different mathematical functions, such as exponential, higher degree polynomials etc, depending on the application. It could however also be a cone defined by straight lines. It does not necessarily have to follow a strict mathematical function either. Thus, in practice it could be the shape that is easiest and most favorable to fabricate.

One criterion that must be met by the hole is that one opening is larger than the other is, and that the diameter is gradually reduced from the larger opening towards the smaller. If not, the method of the invention will not be operable to yield a desired result, namely the merger of two different geometries by a true intersection, as defined previously herein.

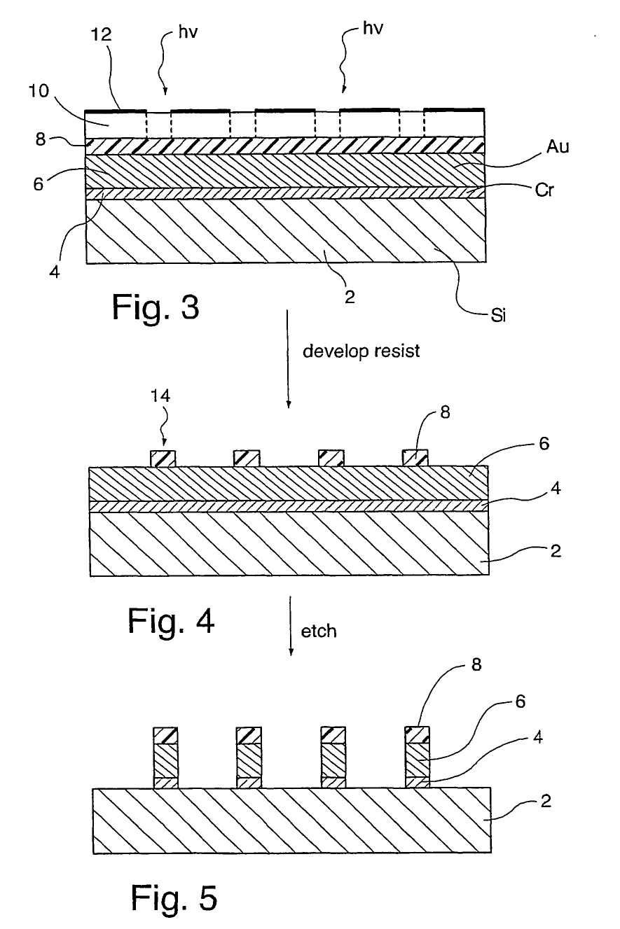

In preferred embodiments the larger hole is essentially circular and has a trumpet like extension into the substrate. The smaller hole can take essentially any shape that can be created by the lithographic techniques known in the art (discussed further below). In FIGS. 2a-c a number of possible shapes are shown. The three-leaf shape, b) in FIG. 2, is preferred for inkjet applications. However, in applications where there is a risk that the particles contained in the liquid could get stuck in the hole, a round shape is preferable. The “kidney” like shape, a) in FIG. 2, could be advantageous in that it is possible to position the tip of the portion extending towards the center, very close to the center, and even at the very center of the hole. In FIG. 2 also the concept of “diameter” as defined above is illustrated, by circumscribing the shapes with a broken line. The “diameter” of the hole is thus the diameter of the circle drawn in broken lines.

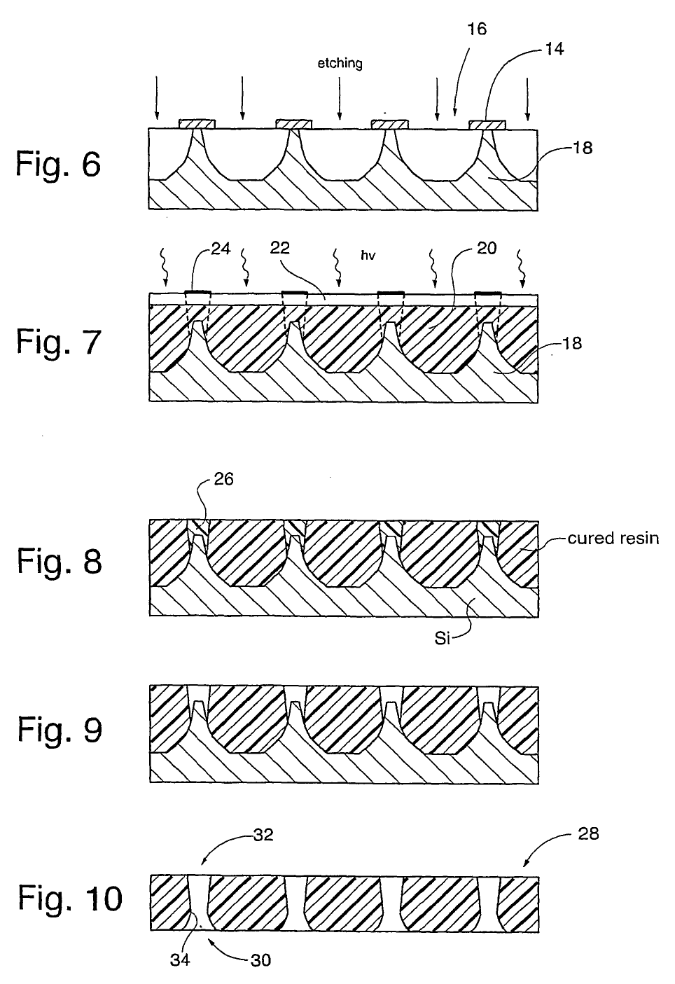

Now the method according to the invention will be described in detail with reference to an embodiment comprising a large circular opening, and a small opening having a cross section as shown in FIG. 2b (“three-leaf clover”). This particular shape has certain very advantageous properties for application in ink jet technology, which will be described further below. The description refers to drawings FIGS. 3-10.

The overall method according to the invention comprises two main steps, namely a first main step of preparing a structured substrate as a template for the part of the structure having the larger opening and a fist part of the channel connecting the openings, said first part having a reducing diameter. It also comprises a second main step of making the second opening and a second part of said channel, whereby said second part merges into the part of the structure by a true intersection as defined previously.

Now the preparation of the structured substrate (template) will be described in detail by way of an example, which is not to be regarded as limiting on the scope of the invention as defined in the claims, and with reference to FIGS. 3-10. The preparation of the template is specifically described for the manufacture of a thin film having holes of a geometry that is suitable for use as nozzles in inkjet printing applications. However, with suitable modifications pertaining to the field of competence of the skilled man, the process is fully workable for other applications as well.

Thus, to begin with a silicon wafer 2 having a diameter of 100 mm (4″) is provided with a crystal orientation of (100). On this silicon wafer a layer 4 of Cr is sputtered to a thickness of 20 nm, followed by a layer 6 of Au to a thickness of 400 nm (see FIG. 3, dimensions not to scale). The Cr bonds the Au to the Si wafer, and the Au prevents that the Si will be etched by the acids used in subsequent steps. These layers form the starting materials for the mask that later will be used to etch the silicon substrate. A lithographic technique is employed to define the pattern for the Au mask. Thus, a resist 8 (a light sensitive polymer) is spun onto the entire disk on the side coated with Cr and Au, as described above. In accordance with standard lithographic procedures common in the art of manufacturing electronic components, a mask on glass 10 defining a pattern is placed above the resist. The pattern can suitably be circular spots 12 having a diameter of 140 μm, spaced at intervals of 170 μm in a regular matrix. The disk with the mask applied is exposed to UV light hv, which will cause polymerization of the resist in the areas not masked. Other parts of the electromagnetic spectrum are also usable, with slight and appropriate modifications of the polymer blend in the resist.

After the resist has been developed (FIG. 4), thus leaving cured spots 14 of resist, the disk is immersed in a gold etchant, e.g. an aqueous solution of KI, I and water (4:1:40) so as to dissolve all Au that is exposed through the resist mask. Next, the disk is immersed in a chromium etchant, (e.g. Merch Chromium etch), wherein the Cr is dissolved (see FIG. 5). Finally, the resist 8 is removed with acetone.

We have now made a mask of gold, having etchable areas 16 defined by the cured resin spots 14, provided on a silicon disk 2.

In order to create trumpet bell like cones on the Si disk an isotropic etch solution is employed. This means that it etches at the same rate in all directions. A suitable solution is HNO₃, HF and H₂O in the ratio 90:5:5, and the etching is carried out at room temperature. This will yield an etching rate of about 1 μm/min. A suitable etching depth, i.e. the height of the final cones, is 65 μm. This rate and depth in combination will give a diameter at the bottom of the etch hole of about 140 μm, and a matrix of “upright pins” 18 having a circular cross section and a curved surface, similar to the bell of a trumpet. Since the etchant is isotropic, the areas between the protruding pins will be essentially flat. The obtained structure constitutes a positive “mold” structure” for the continued process.

Isotropic etching is described in Petersen E., Kurt, “Silicon as a Mechanical Material”, Proc IEEE, vol 70, no 5, pp 420-470, May 1982.

Other shapes of the upright pins are possible to obtain. If the masked areas 14 are rectangular or square, and the etching is anisotropic (different etching rates in different directions), pyramids will form. A suitable etch solution for this purpose is KOH (60% in water). Anisortropic etching is described in Bean E., Kenneth, “Anisotropic Etching of Silicon”, IEEE Transactions on Electron Devices, vol. 25, no 10, October 1978.

Having obtained the desired protruding pins 18 the Au and Cr remaining on top of the pins is removed using the same procedure as when holes were opened in the Au/Cr layer.

The process disclosed above is an embodiment of the first major step in the process according to the invention, namely making a positive mold, and thus resulted in a template for the manufacture of the inventive structure, namely a film having holes with a desired and advanced geometry. In particular the upright pins define the larger first opening and the first part of the channel connecting the openings of the inventive structure, having a reducing diameter.

Now the second major step will be described.

Onto the silicon disc with its protruding pins an UV curing epoxy resin 20 (e.g. SU8 obtainable form Micro Chem. Corp.) is applied by spin-coating, to the desired thickness. For application as a nozzle in ink jet printing a suitable thickness is 60-120, preferably 80-100 μm. In order to remove solvent remaining after the spin-coating step, the disk is heated to 95° C. for about 1 hour.

The thickness of the spin coated epoxy resin must not necessarily be equal to the height of the pins. In fact it can be applied in a thickness that exceeds the height of the pins, or the thickness can be smaller than their height such that the top of the pins extend above the surface of the resin layer.

In order to create the second opening and the part of the channel having the same cross section as the second opening, a new mask 22 is placed above the epoxy resin. The mask need not be in physical contact with the resin layer, and in the case where the pins extend above the resin, the mask can rest on the pins.

The mask is preferably a glass plate 22 on which a pattern of non-transparent areas 24 has been provided by a suitable technique. Mask making is an art well known to the skilled man and need not be further discussed herein. These areas can take any desired shape, such as those shown in FIG. 2. The mask is placed such that the non-transparent spots are aligned with the pins and centered on them (see FIG. 7). Then, the disk is again exposed to UV light in order to polymerize the non-shaded portions. After an appropriate time of exposure (e.g. 150 seconds), and heating to 95° C., the resin is cured in the regions outside the shading spots, as illustrated in FIG. 8. The non-cured parts 26 of the SU8 layer is dissolved in propylene glycol ether acetate, which opens up the holes, as shown in FIG. 9. Finally the resin film is removed mechanically from the Si substrate, and the nozzle structure 28 is ready, as shown in FIG. 10.

FIG. 10 illustrates schematically a structure that is applicable as a nozzle for ink jet applications. Thus it comprises a first opening 30 and a second opening 32 and a transition region 34 between said openings. The size of the first opening/aperture is larger than the size of the second opening. Furthermore, the geometrical shapes of said first and second openings, respectively, are different. Also, in accordance with the invention, the intersection between the different geometrical shapes in said transition region is a true intersection, as previously defined herein.

Optionally, before the non-cured resin is dissolved, a new coating of resin can be applied by spin coating. By the same procedures with a larger mask area over each pin a structure can be made that will function as a mechanical protection, or for providing auxiliary channels on the surface for removing ink that may leak through the holes.

As mentioned above, the shape illustrated in FIG. 2b (“three leaf clover”) has a special utility and certain beneficial properties in the field of ink jet printing. Namely, when drops of ink are expelled through a nozzle of an ink jet printer, the liquid behaves such that the drop leaves a tail at a point of the rim or edge of the exit hole. This gives a small force perpendicularly to the direction of the drop and makes the drop deviate from the desired track. If the tail could leave the rim from a point closer to the center of the hole, the perpendicular force would be reduced and the accuracy of the track would be improved. With the three-leaf shape, the points where each leaf meets another leaf, will be located closer to the center, and the tail will thus preferentially stick to one of these points, and therefore leave the rim closer to the center and thereby give a better accuracy

Suitable applications for the structures obtainable according to the present invention are films with holes having well defined complicated geometries, and in particular having true intersections between different cross sections in different parts of a channel. Such films are e.g. suitable as nozzles for ink jet printers. Suitable dimensions are channel length=60-120, preferably 80-100 μm, cross section size or “diameter” approximately 35 μm. These dimensions are not critical and can vary depending on the application.

If the structures are made in a smaller scale than for the above mentioned application, e.g. channel length 20 μm, diameter 5 μm, they can advantageously be employed as aerosol nozzles for medical and other applications.

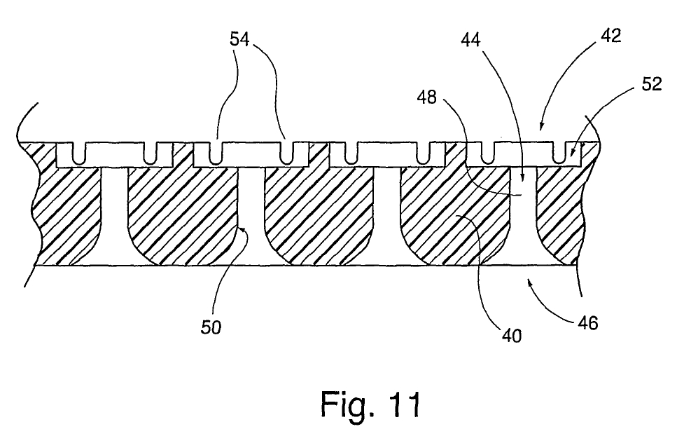

An embodiment of the inventive structure in the form of a miniature nozzle structure having a plurality of nozzles, will now be described with reference to FIG. 11.

FIG. 11 is a cross section through a part of a resin film strip 40, provided with a number of holes 42 arranged in an array, and obtained with the method described above. The structure could be used in an ink jet printing nozzle to provide the desired holes through which the ink is to be expelled in a controlled manner.

Each hole 42 has a first opening 46 and a second opening 44, the diameter of the first opening being larger than the diameter of the second opening. Between the openings a channel 48 forms. The geometries of the respective holes are not indicated in this figure, but for an ink jet printing application, a preferred geometry for the second opening is the three-leaf clover shape b) in FIG. 2. The first opening is preferably circular. The channel 48 has two regions, a first region having the same cross-section as the first opening, and a reducing diameter in the direction towards the second opening, and a second essentially tube shaped region having the same geometry as the second opening 44, and non-changing diameter. Furthermore, there is a transition region 50, where the two different geometries of the respective openings merge into a an intersection that corresponds to a true geometrical intersection, as previously defined herein. In an ink jet application, the first opening 46 will be the inlet opening for the ink, and the second opening 44 will be the exit opening for ilk. In a practical application, a piece of paper on which it is desired to print will be positioned adjacent to, or in very close proximity to, or even in contact with the nozzle structure. It could happen that the structure of the paper, when in contact with the extremely small opening, may damage the edges of the exit opening, thereby causing droplets to be expelled in an uncontrolled manner. To avoid this phenomenon, preferably there is provided a protective structure around the exit hole. Such structure can be achieved by recessing 52 the surface area immediately surrounding the exit opening. As described in the description of the method, this can be done by a further step of deposition of e.g. SU8, and subsequent masking and dissolving. In this way, a paper cannot come into direct contact with the exit opening, and will thus be protected.

Furthermore, sometimes an excess of ink can accumulate in the depression formed in the way described above, and in order to remove this excess, there can be formed channels 54 extending towards the edges of the resin strip.

Other applications that are apparent to the skilled man upon reading the disclosure herein are to be regarded as being within the scope of the appended claims.

1. A method of making holes in an essentially flat member, said holes having an accurately defined geometry, and said holes having a first opening and a second opening, the first opening having a larger diameter than said second opening, whereby the openings define a channel between them, wherein the cross sectional area of the channel diminishes from the first opening towards the second opening up to a transition region where the two differing geometries intersect in a true intersection, the method comprising the steps of:
making a positive mold having protrusions with diminishing cross section dimension towards the top of the protrusions;
applying a light curable resin layer over the positive mold;
masking said curable resin with a mask having a pattern of areas defining a desired geometry of said second openings, said areas being aligned with said protrusions;
exposing the curable resin to curing conditions such that only portions exposed by said mask are cured;
dissolving non-cured resin; and
removing the cured resin layer from the substrate.

2. The method as claimed in claim 1, wherein the step of making a positive mold comprises the steps of:
providing an etchable, flat substrate;
providing the substrate with an etch mask defining a plurality of discrete etchable areas on said substrate;
etching the substrate in said etchable areas to create depressions in said substrate to define said positive mold, leaving said protrusions having diminishing cross section dimension towards the top of the protrusions.

3. The method as claimed in claim 2, wherein the etching of the substrate is an isotropic etching.

4. The method as claimed in claim 2, wherein the etching of the substrate is an anisotropic etching.

5. The method as claimed in claim 2, wherein said mask defining a desired geometry of said second openings, comprises a glass plate with non-transparent areas provided thereon.

6. The method as claimed in claim 5, wherein said non-transparent areas define the geometry of said second openings.

7. The method as claimed in any preceding claim, wherein before the step of dissolving non-cured resin, a further layer of light curable resin is applied; the layer is masked with a mask defining a protective structure that is to surround said second opening; the resin is exposed to curing conditions; and the mask is removed.

8. The method as claimed in claim 7, wherein said mask defines a depression in the top surface of the flat member, said depression surrounding the second opening.

9. The method of claims 8, wherein the mask also defines a channel structure in said top surface.

10. A miniature nozzle (28) structure, comprising an essentially flat member having a top and a bottom surface, and having a first opening (30) provided on said bottom surface, and a second opening (32) provided on the top surface, thereby forming a channel between said openings, and a transition region (34) between said openings, characterized in that
the diameter of the first opening (30) is larger than the diameter of the second opening (32);
the diameter of the channel is reduced in the direction from the first opening towards the second opening and up to the transition region, the diameter of the channel being constant from the transition region and to the second opening; and in that
the intersection between the different geometrical shapes in said transition region (34) corresponds to a true geometrical intersection.

11. The nozzle structure as claimed in claim 10, further comprising a protective structure surrounding the second opening, said structure being in the form of a depression (52) in the top surface.

12. The nozzle structure as claimed in claim 11, comprising channels (54) provided in the top surface, and extending from said depressions (52) towards the periphery of said flat member.

13. The nozzle structure as claimed in claim 10, 11 or 12, wherein the channel comprises a first section having the general shape of a trumpet bell, and a second section having a general shape of a tube.

14. The nozzle structure as claimed in claim 13, wherein the second section has a cross section of a clover leaf shape.

15. The nozzle structure as claimed in claim 13, wherein the second section has a cross section of a kidney shape.

16. The method as claimed in any preceding claim, wherein the geometrical shapes of said first and second openings (30, 32), respectively, are different;

17. An ink jet printer nozzle comprising a nozzle structure as claimed in claim 10.

18. An ink jet printer comprising a nozzle as claimed in claim 17.
